(19) United States
(12) Patent Application Publication
(10) Pub. No.: US 2014/0300611 A1
(43) Pub. Date: Oct. 9, 2014

(54) WEB AND NATIVE CODE ENVIRONMENT MODULAR PLAYER AND MODULAR RENDERING SYSTEM

(71) Applicant: Trigger Happy, Ltd., Aukland (NZ)

(72) Inventors: James Gordon, Aukland (NZ); Karl Butler, Aukland (NZ)

(73) Assignee: Trigger Happy, Ltd., Aukland (NZ)

(21) Appl. No.: 14/216,490

(22) Filed: Mar. 17, 2014

Related U.S. Application Data
(60) Provisional application No. 61/790,524, filed on Mar. 15, 2013.

(51) Int. Cl. G06T 13/80

(52) U.S. Cl. CPC G06T 13/80
USPC 345/473

(57) ABSTRACT

A system can include a modular player configured to receive input data, analyze the input data, and provide first output data. The system can further include a scene graph module configured to receive the first output data from the modular player, allocate a hierarchy structure based on the first output data, and provide second output data. The system can further include a modular renderer configured to receive the second output data and provide third output data as a visual representation.

### CROSS-REFERENCE TO RELATED APPLICATION

This application claims the benefit of U.S. Provisional Patent Application No. 61/790,524, titled “WEB AND NATIVE CODE ENVIRONMENT MODULAR PLAYER AND MODULAR RENDERING SYSTEM” and filed on Mar. 15, 2013, which is hereby incorporated herein by reference in its entirety.

### TECHNICAL FIELD

The disclosed technology pertains generally to systems for displaying scenes and animations, with particular regard to systems that include the use portable electronic devices such as tablets and smartphones.

### BACKGROUND

The use of portable electronic devices such as tablet computing devices and smartphones has skyrocketed in recent years. Animation, including custom animation, has also seen significant increase in use. The complexity of animation rendering is great, however, and does not usually transfer well to a portable electronic device. Accordingly, a need remains for effective rendering, with particular regard to display on portable electronic devices.

### BRIEF DESCRIPTION OF THE DRAWINGS

FIG. 1 is a block diagram illustrating an example of a modular player and modular rendering system in accordance with certain embodiments of the disclosed technology.

FIG. 2 is a flowchart illustrating an example of a method performed by a modular player in accordance with certain embodiments of the disclosed technology.

FIG. 3 is a flowchart illustrating an example of a method performed by a scene graph component in accordance with certain embodiments of the disclosed technology.

FIG. 4 is a flowchart illustrating an example of a method performed by a modular renderer in accordance with certain embodiments of the disclosed technology.

### DETAILED DESCRIPTION

Embodiments of the disclosed technology are generally directed to a flexible, modular, cross-platform system configured to allow representation of complex scenes and animations that can be displayed in a multitude of different ways on top of HTML Canvas technology, or other similar platforms. In such embodiments, any spatial data (e.g., positions, geomathical data, assets, entity, nodes, and images) that is sent in a data format via the described render engine will advantageously display as a visual representation on the HTML Canvas.

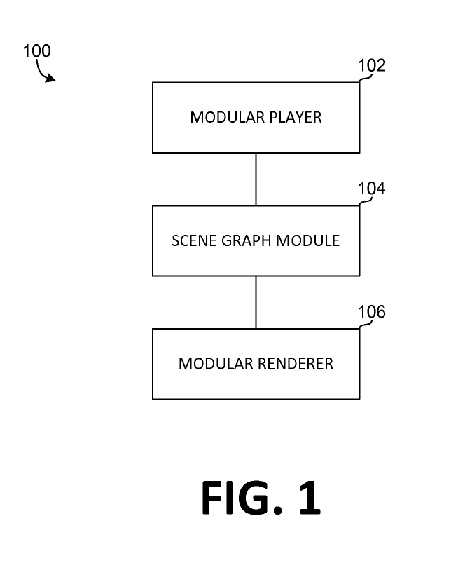

FIG. 1 is a block diagram illustrating an example of a modular player and modular rendering system 100 in accordance with certain embodiments of the disclosed technology. In the example, the modular player and modular rendering system 100 includes a modular player 102, a scene graph module 104, and a modular renderer 106, all of which are described in detail below.

An application on any third-party interface platform, e.g., glass screens on touch screen devices using operating systems such as iOS, Windows 8, or Android, for example, or within a computing device that uses a mouse or tablet, may capture information presented through user interactions with touch screens, such as strokes and gestures. For example, a user may move his or her finger in a circle to draw a circle, perform a pinch action to scale a displayed object, draw lines with a tablet, or create vector shapes using a mouse or other suitable input device.

A modular player as described herein will generally correspond with the user's choice of player requirements. For example, the modular player may determine whether the user is making an animation sequence, an interactive book, an interactive comic, or a game, for example. A determination as to the type of player thus determines the data which may be sent to a scene graph module, which is described below.

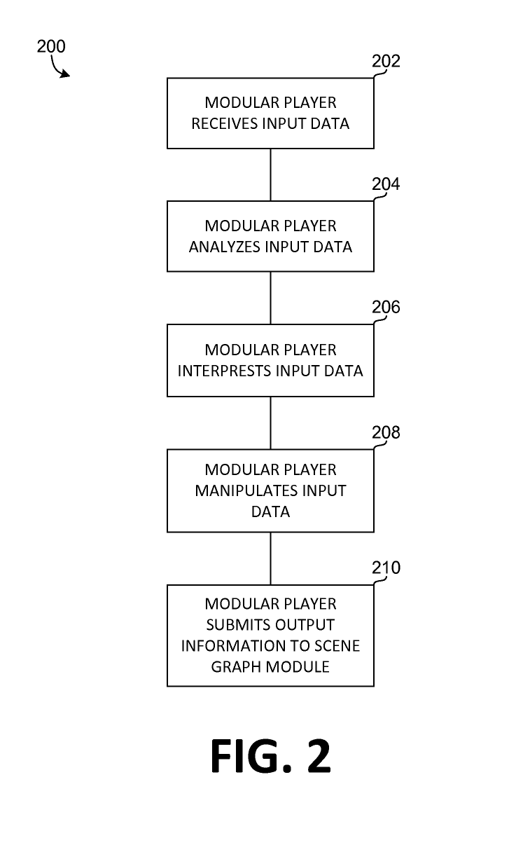

FIG. 2 is a flowchart illustrating an example of a method 200 performed by a modular player (also referred to herein as a Player) in accordance with certain embodiments of the disclosed technology. At 202, the modular player receives input data, e.g., corresponding to a user's interactions with a touch screen. At 204, the modular player analyzes the received data. At 206, the modular player interprets the received data. At 208, the modular player manipulates the received data. At 210, the modular player submits output information to a scene graph module.

As indicated above, information is sent to the Scene Graph from the Player. The data format of the sent information is dependent on the Play mode chosen by the user. Between the output of the Player onto the Scene Graph is where the hierarchy structure is allocated, e.g., in order to determine how each relates to the other.

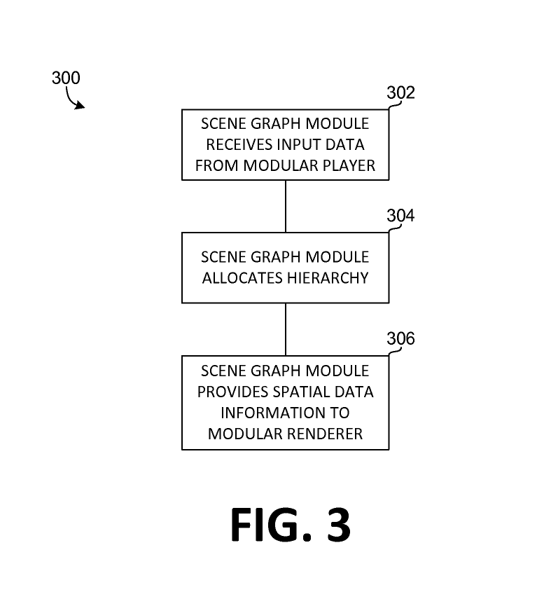

FIG. 3 is a flowchart illustrating an example of a method 300 performed by a scene graph module (also referred to herein as a Scene Graph) in accordance with certain embodiments of the disclosed technology. At 302, the scene graph module receives input data from the modular player. At 304, the scene graph module allocates a hierarchy based on the input data received at 302. At 306, the scene graph module provides spatial data information, such as positions, assets, nodes, entities, images, and geomathical data, for example, to the modular renderer.

The Renderer may pull in spatial data information (e.g., positions, assets, nodes, entities, images, and geomathical data) from the Scene Graph and then output such information as a visual representation on the HTML Canvas, for example. The Renderer may also be modular and able to be used as Canvas 2D or Web GL or any similar web visual interface system.

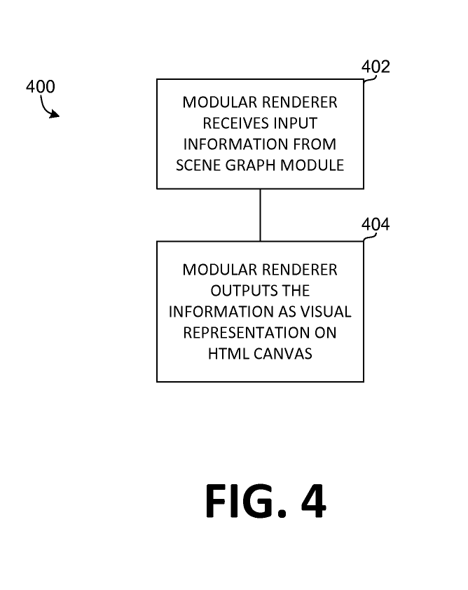

FIG. 4 is a flowchart illustrating an example of a method 400 performed by a modular renderer (also referred to herein as a Renderer) in accordance with certain embodiments of the disclosed technology. At 402, the modular renderer receives input information from the scene graph module. At 404, the modular renderer outputs the information as a visual representation on the HTML Canvas.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, communications devices such as cellular phones and smart phones, and the like. These machines may be implemented as part of a cloud computing arrangement.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices, e.g., keyboards, touch screens, mice, and audio devices such as a microphone, as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, non-transitory physical storage media. Certain outputs may be in any of a number of different output types such as audio or text-to-speech, for example.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A system, comprising:
a modular player configured to receive input data, analyze the input data, and provide first output data;
a scene graph module configured to receive the first output data from the modular player, allocate a hierarchy structure based on the first output data, and provide second output data; and
a modular renderer configured to receive the second output data and provide third output data as a visual representation.

2. The system of claim 1, wherein the modular player is further configured to interpret the input data.

3. The system of claim 1, wherein the modular player is further configured to manipulate the input data.

4. The system of claim 1, wherein the modular renderer is configured to provide the third output data as a visual representation on the HTML Canvas.

5. The system of claim 1, wherein the input data corresponds to at least one user interaction with a touch screen.

6. A machine-controlled method, comprising:
a modular player receiving input data, analyzing the input data, and providing first output data;
a scene graph module receiving the first output data from the modular player, allocating a hierarchy structure based on the first output data, and providing second output data; and
a modular renderer receiving the second output data and providing third output data as a visual representation.

7. The machine-controlled method of claim 6, further comprising the modular player interpreting the input data.

8. The machine-controlled method of claim 6, further comprising the modular player manipulating the input data.

9. The machine-controlled method of claim 6, wherein the modular renderer provides the third output data as a visual representation on the HTML Canvas.

10. The machine-controlled method of claim 6, wherein the input data corresponds to at least one user interaction with a touch screen.

11. One or more tangible, non-transitory machine-readable storage media configured to store machine-executable instructions that, when executed by a processor, cause the processor to perform the machine-controlled method of claim 6.
